(19) United States
(12) Patent Application Publication
(10) Pub. No.: US 2006/0089175 A1
(43) Pub. Date: Apr. 27, 2006

(54) Call switchover in wireless headset

(75) Inventors: Chan Phill Yun, Seoul (KR); Min Jung Kim, Seoul (KR); Jin Ho Son, Seoul (KR)

Correspondence Address: JONATHAN Y. KANG, ESQ.;LE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/245,526

(22) Filed: Oct. 7, 2005

(30) Foreign Application Priority Data
Oct. 8, 2004 (KR) 2004-0080554

(51) Int. Cl. H04B 1/38

(52) U.S. Cl. 455/567; 455/557; 455/41.2

(57) ABSTRACT

A method for call switchover in a wireless headset that is wirelessly coupled to a mobile station comprises transmitting user input related to a call service from the wireless headset to the mobile station. The method also comprises determining whether the user input related to the call service is received during a preset threshold time while a call is ongoing, the call being wirelessly executed by the wireless headset via the mobile station. The method also comprises performing a call switching operation associated with the call service based on whether the user input related to the call service is received during the preset threshold time while the call is ongoing. The wireless headset and the mobile station may be interconnected via a short-range wireless communication to execute telephone communication. The short-range wireless communication may comprise a Bluetooth (BT) wireless communication to form a synchronous connection oriented (SCO) link.

### CROSS-REFERENCE TO RELATED APPLICATIONS

Pursuant to 35 U.S.C. § 119(a), this application claims the benefit of earlier filing date and right of priority to Korean Application No. 2004-0080554, filed on Oct. 8, 2004, the contents of which are hereby incorporated by reference herein in their entirety.

### FIELD OF THE INVENTION

The present invention relates generally to a wireless headset and, more particularly, to call switchover in a wireless headset.

### BACKGROUND OF THE INVENTION

Various short-range wireless communication technologies have been developed in recent years. One such technology is Bluetooth (BT), with version 1.0 published as an official standard in July, 1999. The maximum data transmission speed of Bluetooth is 1 Mbps. Maximum transmission distance is approximately 10 meters with 1 mW of transmission power. Maximum transmission power is 100 Mw.

The BT operates in the unlicensed ISM (Industrial, Scientific, Medical) band at 2.4000˜2.4835 GHz. The BT may configure 79 channels on a 1 MHz bandwidth and may transmit data by switching channels approximately 1,600 times per second using the Frequency Hopping Spread Spectrum method. Using this method, the BT may accurately transmit data even in a noisy environment. Furthermore, the BT may avoid frequency interference by hopping to a new channel frequency after transmission and reception of a predetermined packet. The BT communication may hop faster than other systems operating in the same frequency bandwidth, and may transmit data more stably using a shorter packet.

In addition to the BT, various other short-range wireless communication technologies have been developed including Zigbee, UWB (Ultra Wide Band) and LAN (Local Area Network). Furthermore, along with the development of short-range wireless communication technologies, various service functions have been developed for user convenience. One such function connects a wireless headset to a mobile station via short-range wireless communication. A link is formed for transmission of voice signals between the wireless headset and the mobile station, such that a user may engage in two-way communication without manipulating controls of the mobile station. This function is further described with reference to FIGS. 1a and 1b, below.

FIG. 1a is a diagram illustrating a related art operation in which a mobile station is connected to a wireless headset for telephone communication.

A mobile station (100) is connected to a wireless headset (110) via a short-range wireless communication when a call signal is received (S100). The mobile station (100) transmits a ring signal to the wireless headset (110) to advise the user that the call signal has been received (S102). In such case, if the user presses a function key disposed on the wireless headset (110) to initiate a telephone communication (S104), the wireless headset (110) creates a Command of Keypad (CKPD) message to indicate that the function key has been pressed, and transmits the CKPD message to the mobile station (100) (S106).

The mobile station (100), in turn, transmits a confirm message (e.g., OK) to the wireless headset (110) (S108). The mobile station (100) then receives the call in response to the call signal and forms a Synchronous Connection Oriented (SCO) link to transmit a voice signal between the wireless headset (110) and the mobile station (100) (S110). Once the SOC link is formed, a voice signal may be exchanged between the mobile station (100) and the wireless headset (110) such that a user may use the wireless headset (110) to implement a telephone communication with the call received by the mobile station (100).

FIG. 1b is a diagram illustrating a related art operation in which a wireless headset is connected to a mobile station for telephone communication.

When a user of the wireless headset (110) desires to perform a telephone communication via the mobile station (100), the user presses a function key disposed on the wireless headset (110) (S150). The wireless headset (110) is then connected to the mobile station (100) via a short-range wireless communication (S152).

Once the mobile station (100) and the wireless headset (110) are connected, the wireless headset (110) transmits a CKPD message generated in response to the depression of the function key (S154) to the mobile station (100). The mobile station (100), in turn, transmits a confirm message (e.g., OK) to the wireless headset (110) (S156), and an SCO link is formed between the wireless headset (110) and the mobile station (100) (S158).

The mobile station (100) also dials a predetermined telephone number in response to the CKPD message following the formation of the SCO link. For example, the mobile station (100) may re-dial a last-dialed telephone number to call the party called previously.

If the called party receives the telephone call in response to the re-dialing, a voice signal is exchanged between the mobile station (100) and the wireless headset (110) via the SCO link, whereby the user may perform a telephone communication with a call made by the mobile station (100) in response to the depression of the function key disposed on the wireless headset (110).

If the short-range wireless communication uses the BT, the wireless headset (110) must satisfy a headset profile version 1.1, which has only one control command. As a result, the wireless headset (110) may only be equipped with one function key, and as the user depresses the function key, the mobile station must discriminate between call reception, re-dialing and termination of communication based on the current operational state, and then implement an appropriate operation.

For example, if the user presses a function key of the wireless headset (110) to prompt the mobile station (100) to receive a CKPD message while the mobile station (100) receives a call signal, the mobile station (100) receives the call signal in response to the CKPD message, and the user may conduct a telephone communication. Alternatively, if a user presses a function key of the wireless headset (110) to prompt the mobile station (100) to receive the CKPD message while the mobile station (100) is not in the course of telephone communication, the mobile station (100) determines to re-dial in response to the CKPD message, and then re-dials the last-dialed telephone number. Furthermore, if the user presses a function key of the wireless headset (110) to prompt the mobile station (100) to receive the CKPD message while the mobile station (100) is in the course of telephone communication, the mobile station terminates the telephone communication in response to the CKPD message.

Another call-related service provides a call standby function for a mobile station that receives a second call while a first call is ongoing. The call standby function operates such that if a mobile station receives a call signal while the mobile station is currently in telephone communication, the mobile station indicates to the user via a warning sound such as a ring, a tone, or a beep, that a call is incoming. Then, the user may depress a call transfer key on a key pad to cause the mobile station to place the current call on standby, and transfer to the new call signal. If the user depresses the call transfer again, the new call is placed on standby and the mobile station transfers back to the original call.

However, the call standby function is only embodied in the mobile station and may not be executed while a wireless headset is used for the call. This may result in disablement of the call standby function when a call is in process using the wireless headset.

### SUMMARY OF THE INVENTION

Accordingly, the present invention is directed to call switchover in a wireless headset that substantially obviates one or more problems due to limitations and disadvantages of the related art.

An object of the present invention is to provide for call switchover in a wireless headset using a function key disposed on the wireless headset, thus enabling call standby while telephone communication is in progress.

Another object of the present invention is to provide call standby during a time interval in which a function key disposed on the wireless headset is continuously depressed. To this end, the present invention establishes a pre-set threshold time for a mobile station. The mobile station counts for a time interval during which a Command of Keypad (CKPD) message is continuously inputted, and if the counted time interval is not below the threshold time, an original operation is carried out in response to the CKPD message. For example, if the CKPD message is inputted, the mobile station carries out call reception, re-dialing or communication termination in response to the current status of the mobile station.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a method for call switchover in a wireless headset that is wirelessly coupled to a mobile station comprises transmitting user input related to a call service from the wireless headset to the mobile station. The method also comprises determining whether the user input related to the call service is received during a preset threshold time while a call is ongoing, the call being wirelessly executed by the wireless headset via the mobile station. The method also comprises performing a call switching operation associated with the call service based on whether the user input related to the call service is received during the preset threshold time while the call is ongoing.

The wireless headset and the mobile station may be interconnected via a short-range wireless communication to execute telephone communication. The short-range wireless communication may comprise a Bluetooth (BT) wireless communication to form a synchronous connection oriented (SCO) link to exchange a voice signal between the wireless headset and the mobile station. The user input may be continuously received from a user and transmitted from the wireless headset to the mobile station during the pre-set threshold time or the user input may be received from the user and transmitted from the wireless headset to the mobile station twice during the pre-set threshold time to cause the performing of the call switching operation associated with the call service. The pre-set threshold time may be 0.7 sec. The call switching operation associated with the call service may be one of call reception, call re-dialing or call termination.

In another embodiment, a method for call switchover in a wireless headset that is wirelessly coupled to a mobile station comprises receiving notification at the wireless headset from the mobile station that a second call is waiting while a first call is ongoing, the first call being wirelessly executed by the wireless headset via the mobile station. The method also comprises transmitting user input related to the second call from the wireless headset to the mobile station. The method also comprises determining whether the user input related to the second call is received during a preset threshold time while the first call is ongoing. The method also comprises transferring to the second call based on whether the user input related to the second call is received during the preset threshold time while the first call is ongoing. The method may further comprise continuing the first call if the second call is not waiting.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1a is a diagram illustrating a related art operation in which a mobile station is connected to a wireless headset for telephone communication.

FIG. 1b is a diagram illustrating a related art operation in which a wireless headset is connected to a mobile station for telephone communication.

FIG. 2 is a block diagram illustrating a structure of a mobile station, according to an embodiment of the present invention.

FIG. 3 is a block diagram illustrating a structure of a wireless headset, according to an embodiment of the present invention.

FIG. 4 is a flow diagram illustrating a communication method, according to an embodiment of the present invention.

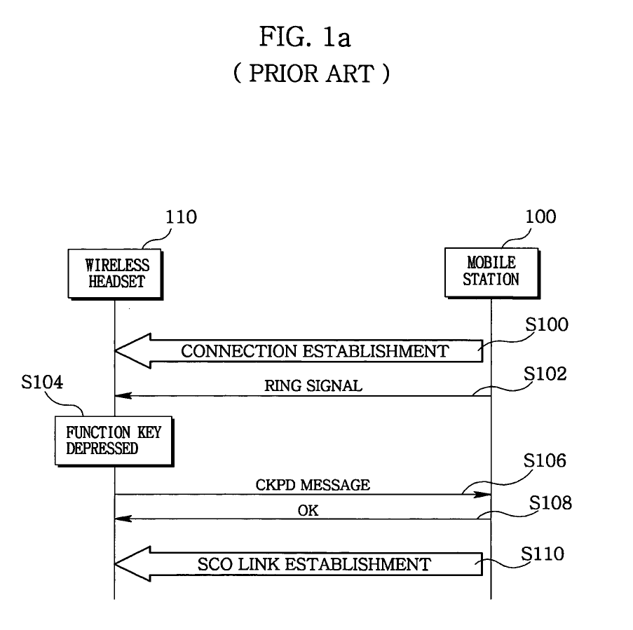

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

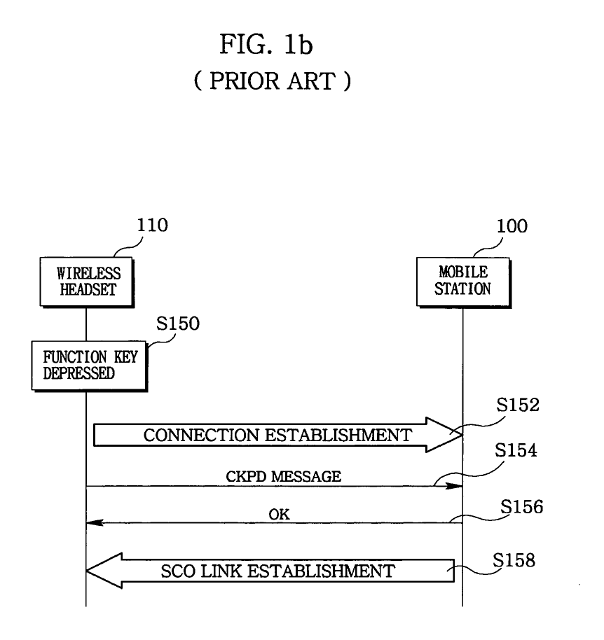

FIG. 2 is a block diagram illustrating a structure of a mobile station (250), according to an embodiment of the present invention.

Referring to FIG. 2, a controller (200) controls overall operation of the mobile station (250). For example, the controller (200) performs sound and data communication and control thereof, and supports a telephone communication using a wireless headset. The controller (200) may be include a one chip micro processor, for example, and may utilize a modem, such as a mobile station modem (MSM).

Reference numeral 202 is a Radio Frequency (RF) module and 204 is a base band processor. The RF module (202) receives an RF signal via an antenna, converts the received RF signal to a base band signal, and provides the base band signal to the base band processor (204). The RF module (202) also converts the base band signal to an RF signal and transmits the RF signal via the antenna. The base band processor (204) is located between the RF module (202) and the controller (200), and processes the received and transmitted base band signal. For example, the RF module (202) may perform the function of channel coding and spreading the transmitted signal outputted from the controller (200) if a predetermined signal is transmitted. Furthermore, the RF module (202) may perform the function of restoring the received signal by despreading and channel decoding if a predetermined signal is received.

Reference numeral 206 is a short-range communication module. The short-range communication module (206) implements a short-range wireless communication in response to the control of the controller (200) and is connected to the wireless headset. The short-range communication module (206) forms a predetermined link, such as an SCO link, between the wireless headset and the short-range communication module (206), and exchanges a sound signal therebetween. The short-range communication module (206) may use BT, Zigbee, UWB or wireless LAN, for example.

Reference numeral 208 is a sound signal processor. The sound signal processor (208) decodes a sound signal received by the short-range communication module (206). The sound signal processor (208) also encodes a sound signal to be transmitted to a wireless headset and outputs the sound signal to the short-range communication module (206).

Reference numeral 210 is a telephone communication unit. The telephone communication unit (210) inputs a sound signal inputted through a microphone (212) to the base band processor (204) in response to control by the controller (200). The telephone communication unit (210) outputs the sound signal received by the RF module (202) and processed by the base band processor (204) to a speaker (214), enabling a user to perform a telephone communication.

Reference numeral 216 is a key pad. The key pad (216) is composed of a plurality of function keys including number keys (0˜9), menu, confirmation, clear (CLR), end (END), *, and # keys. The key pad (216) creates related key input data in response to depression of a predetermined function key by the user.

Reference numeral 218 is a display unit. The display unit (218) displays an operational status of a mobile station in response to control by the controller (200). The display unit (218) displays numbers, characters and symbols inputted by manipulation of the key pad (216) by the user, according to the control by the controller (200).

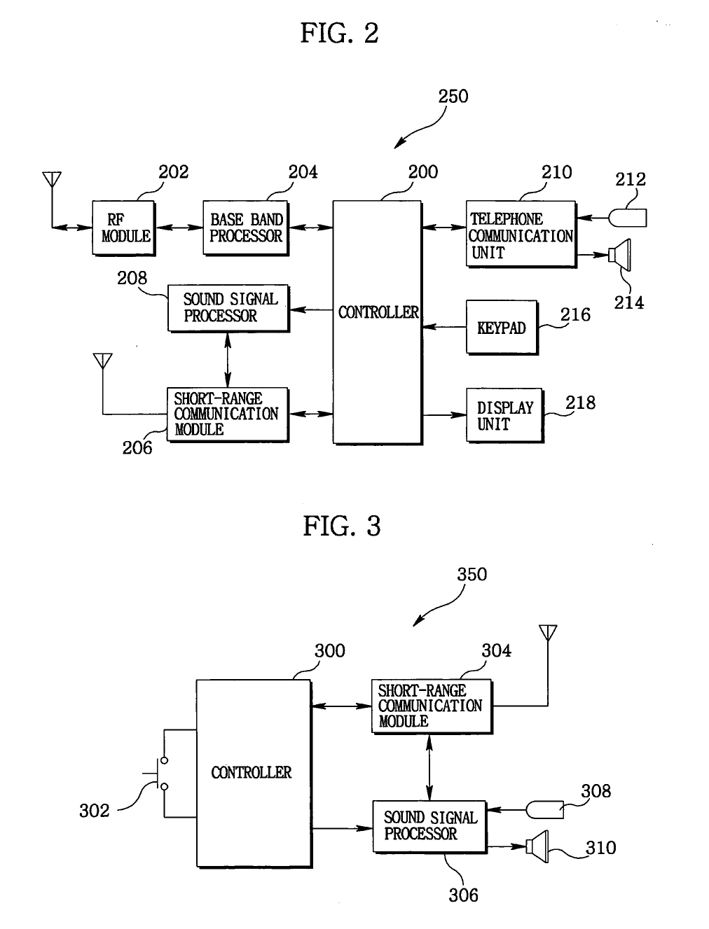

FIG. 3 is a block diagram illustrating a structure of a wireless headset (350), according to an embodiment of the present invention.

Referring to FIG. 3, reference numeral 300 is a controller and 302 is a function key. The controller (300) controls implementation of a short-range wireless communication with a mobile station. The controller (300) creates a CKPD message when a user depresses the function key and controls transmission of the created CKPD message to the mobile station via the short-range wireless communication.

Reference numeral 304 is a short-range communication module. The short-range communication module (304), similar to the short-range communication module (206), is connected to the wireless headset and implements a short-range wireless communication in response to control by the controller (300). The short-range communication module (304) forms a predetermined link (e.g., an SCO link) between the mobile station and the short-range communication module (304) and exchanges a sound signal therebetween. The short-range communication module (304) may use BT, Zigbee, UWB or wireless LAN, for example.

Reference numeral 306 is a sound signal processor. The sound signal processor (306) encodes a sound signal inputted from a microphone (308) and outputs the sound signal to the short-range communication module (304). The sound signal processor (306) decodes the sound signal received by the short-range communication module (304) and outputs the sound signal to a speaker (310), thereby enabling the user to perform telephone communication.

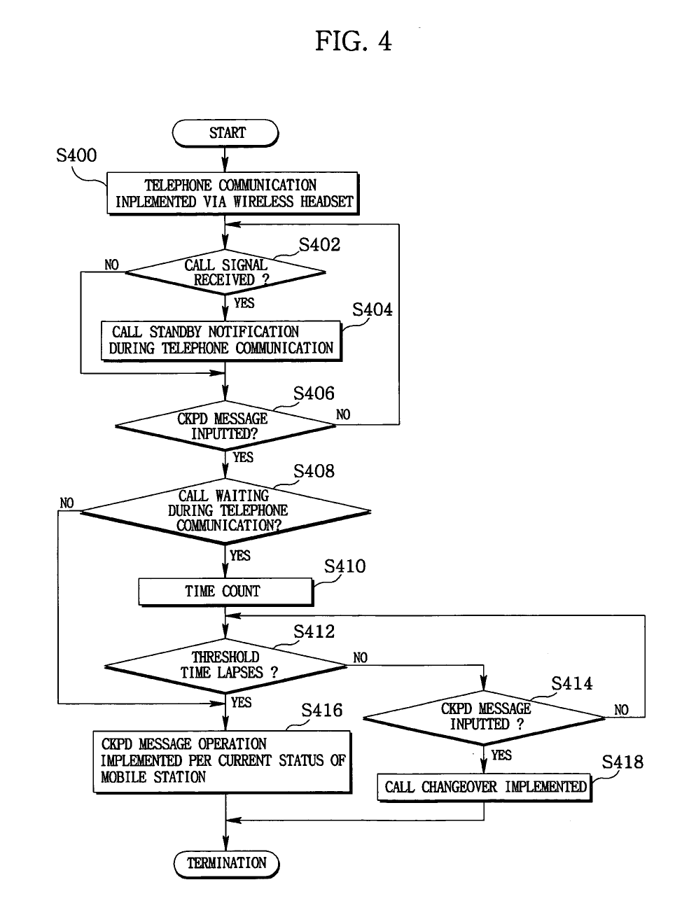

FIG. 4 is a flow diagram illustrating a communication method, according to an embodiment of the present invention.

Referring to FIG. 4, a wireless headset and a mobile station are interconnected via the short-range wireless communication to carry out the telephone communication when a user uses the wireless headset to implement a telephone communication (S400). For example, if a call signal is received by the mobile station, a ring signal is transmitted to the wireless headset, indicating to the user that a call signal has been received. If the user depresses the function key (302) while the reception of the call signal is indicated, the wireless headset and the mobile station form a link to exchange a sound signal to enable execution of the telephone communication.

Furthermore, if a user provides user input, for example by depressing the function key (302) disposed on the wireless headset, the wireless headset notifies the mobile station via the CKPD message. The mobile station may then re-dial the number the mobile station last dialed in response to the CKPD message. The wireless headset and the mobile station then form a link for transmission of a voice signal for a telephone communication.

The controller (200) of the mobile station determines whether a call signal has been received while telephone communication is in progress via the base band processor (204) of the RF module (202) while the user uses the wireless headset to make a telephone communication (S402). If the determination at step (S402) finds that the call signal has been received, the controller (200) creates a warning sound, indicating that a call has been received, and transmits the created warning sound to the wireless headset, indicating that a call is waiting (S404).

In other words, the controller (200) creates a warning sound and transmits the created warning sound via the short-range communication module (206). The transmitted warning sound is received by the wireless headset via the short-range communication module, and the received warning sound is processed by the sound signal processor (306). The processed warning sound is then outputted to the speaker (310) to notify the user that a call is waiting, during the present telephone communication.

The controller (200) determines whether the CKPD message has been inputted from the wireless headset (S406). That is, if the user hears the warning sound of a waiting call outputted from the speaker (310) and depresses the function key (302) for call changeover, the controller (300) generates a CKPD message to indicate that the function key (302) has been depressed. The generated CKPD message is then transmitted via the short-range communication module (306). The transmitted CKPD message is received by the short-range communication module (206) of the mobile station and is again received by the controller (200). The controller (200) determines whether the CKPD message has been inputted from the short-range communication module (206) (S406).

If the determination in step (S406) finds that the CKPD message has not been inputted, the controller (200) returns to (S402), and conducts repeated operations of indicating that a call is waiting during the present telephone communication (S404). However, if the determination in step (S406) finds that the CKPD message has been inputted, the controller (200) determines whether a call is waiting during the present telephone communication (S408). If the determination in step (S408) finds that that there is no waiting call, the controller (200) performs an operation related to the CKPD message based on the current status of the mobile station. For example, the controller (200) may terminate the telephone communication if it is still being executed.

However, if the determination in step (S408) finds that there is a waiting call during telephone communication, the controller (200) counts time (S410) and determines whether a preset threshold time has lapsed (S412). If the preset threshold time has not lapsed, the controller (200) determines whether the CKPD message has been inputted (S414).

If the CKPD message has not been inputted by the time when the threshold time lapses, the controller (200) implements an operation related to the CKPD message based on the current status of the mobile station (S416). However, if the CKPD message has been inputted before the lapse of the threshold time, the controller (200) implements a changeover from an active call to a waiting call (S418), enabling the user to make a telephone communication with the waiting call.

For example, if the threshold time is 0.7 sec and a time interval between the two incoming CKPD messages is within 0.7 sec, the controller (200) of the mobile station determines that a call changeover is necessary, places the active call on standby, and changes the active call to a waiting call, thereby enabling the user to make a telephone communication with the waiting call.

In one embodiment, a method for call switchover in a wireless headset that is wirelessly coupled to a mobile station comprises transmitting user input related to a call service from the wireless headset to the mobile station. The method also comprises determining whether the user input related to the call service is received during a preset threshold time while a call is ongoing, the call being wirelessly executed by the wireless headset via the mobile station. The method also comprises performing a call switching operation associated with the call service based on whether the user input related to the call service is received during the preset threshold time while the call is ongoing.

The wireless headset and the mobile station may be interconnected via a short-range wireless communication to execute telephone communication. The short-range wireless communication may comprise a Bluetooth (BT) wireless communication to form a synchronous connection oriented (SCO) link to exchange a voice signal between the wireless headset and the mobile station. The user input may be continuously received from a user and transmitted from the wireless headset to the mobile station during the pre-set threshold time or the user input may be received from the user and transmitted from the wireless headset to the mobile station twice during the pre-set threshold time to cause the performing of the call switching operation associated with the call service. The pre-set threshold time may be 0.7 sec. The call switching operation associated with the call service may be one of call reception, call re-dialing or call termination.

In another embodiment, a method for call switchover in a wireless headset that is wirelessly coupled to a mobile station comprises receiving notification at the wireless headset from the mobile station that a second call is waiting while a first call is ongoing, the first call being wirelessly executed by the wireless headset via the mobile station. The method also comprises transmitting user input related to the second call from the wireless headset to the mobile station. The method also comprises determining whether the user input related to the second call is received during a preset threshold time while the first call is ongoing. The method also comprises transferring to the second call based on whether the user input related to the second call is received during the preset threshold time while the first call is ongoing. The method may further comprise continuing the first call if the second call is not waiting.

As apparent from the forgoing of the present invention, if there is a call waiting, the mobile station determines whether a CKPD message has been inputted from a wireless headset within a present threshold time. A call changeover is performed if the CKPD message has been inputted within the present threshold time. Therefore, according to the present invention, a singular function key may be used to embody a call waiting function for telephone communication even if a wireless headset is used, such as a wireless headset that satisfies the headset profile version 1.1 of BT and only one control command is available with the function key.

It will be apparent to those skilled in the art that various modifications and variations may be made in the present invention without departing from the spirit or scope of the inventions. Thus, it is intended that the present invention covers the modifications and variations of this invention provided they come with in the scope of the appended claims and their equivalents.

What is claimed is:

1. A method for call switchover in a wireless headset that is wirelessly coupled to a mobile station, the method comprising:
transmitting user input related to a call service from the wireless headset to the mobile station;
determining whether the user input related to the call service is received during a preset threshold time while a call is ongoing, the call being wirelessly executed by the wireless headset via the mobile station; and
performing a call switching operation associated with the call service based on whether the user input related to the call service is received during the preset threshold time while the call is ongoing.

2. The method of claim 1, wherein the wireless headset and the mobile station are interconnected via a short-range wireless communication to execute telephone communication.

3. The method of claim 2, wherein the short-range wireless communication comprises a Bluetooth (BT) wireless communication to form a synchronous connection oriented (SCO) link to exchange a voice signal between the wireless headset and the mobile station.

4. The method of claim 1, wherein the user input is continuously received from a user and transmitted from the wireless headset to the mobile station during the pre-set threshold time or the user input is received from the user and transmitted from the wireless headset to the mobile station twice during the pre-set threshold time to cause the performing of the call switching operation associated with the call service.

5. The method of claim 4, wherein the pre-set threshold time is 0.7 sec.

6. The method of claim 1, wherein the call switching operation associated with the call service is one of call reception, call re-dialing or call termination.

7. A method for call switchover in a wireless headset that is wirelessly coupled to a mobile station, the method comprising:
receiving notification at the wireless headset from the mobile station that a second call is waiting while a first call is ongoing, the first call being wirelessly executed by the wireless headset via the mobile station;
transmitting user input related to the second call from the wireless headset to the mobile station;
determining whether the user input related to the second call is received during a preset threshold time while the first call is ongoing; and
transferring to the second call based on whether the user input related to the second call is received during the preset threshold time while the first call is ongoing.

8. The method of claim 7, wherein the wireless headset and the mobile station are interconnected via a short-range wireless communication to execute telephone communication.

9. The method of claim 8, wherein the short-range wireless communication comprises a Bluetooth (BT) wireless communication to form a synchronous connection oriented (SCO) link to exchange a voice signal between the wireless headset and the mobile station.

10. The method of claim 7, wherein the user input is continuously received from a user and transmitted from the wireless headset to the mobile station during the pre-set threshold time or the user input is received from the user and transmitted from the wireless headset to the mobile station twice during the pre-set threshold time to cause the transferring to the second call.

11. The method of claim 10, wherein the pre-set threshold time is 0.7 sec.

12. The method of claim 7, wherein the transferring to the second call comprises one of call reception, call re-dialing or call termination.

13. The method of claim 7, further comprising:
continuing the first call if the second call is not waiting.

14. A communication system comprising a mobile station wirelessly coupled to a wireless headset, the communication system adapted for call switchover and comprising:
means for transmitting user input related to a call service from the wireless headset to the mobile station;
means for determining whether the user input related to the call service is received during a preset threshold time while a call is ongoing, the call being wirelessly executed by the wireless headset via the mobile station; and
means for performing a call switching operation associated with the call service based on whether the user input related to the call service is received during the preset threshold time while the call is ongoing.

15. The communication system of claim 14, wherein the wireless headset and the mobile station are interconnected via a short-range wireless communication to execute telephone communication.

16. The communication system of claim 15, wherein the short-range wireless communication comprises a Bluetooth (BT) wireless communication to form a synchronous connection oriented (SCO) link to exchange a voice signal between the wireless headset and the mobile station.

17. The communication system of claim 14, wherein the user input is continuously received from a user and transmitted from the wireless headset to the mobile station during the pre-set threshold time or the user input is received from the user and transmitted from the wireless headset to the mobile station twice during the pre-set threshold time to cause the performing on the call switching operation associated with the call service.

18. The communication system of claim 17, wherein the pre-set threshold time 0.7 sec.

19. The communication system of claim 14, wherein the call switching operation associated with the call service is one of call reception, call re-dialing or call termination.

20. The communication system of claim 14, further comprising:
means for continuing the call if no other call is waiting.
